(19) United States
(12) Patent Application Publication
(10) Pub. No.: US 2011/0056883 A1
(43) Pub. Date: Mar. 10, 2011

(54) Filter Segment for Use in a Filtration Device and a Circular Segment for Holding a Filter Segment

(75) Inventors: THOMAS KERL, Muhlhausen (DE); Oliver Rong, Berching (DE); Torsten Wittmann, Berching (DE); Stefan Reber, Nurnberg (DE)

(73) Assignee: HUBER SE, Berching (DE)

(21) Appl. No.: 12/876,618

(22) Filed: Sep. 7, 2010

(30) Foreign Application Priority Data
Sep. 7, 2009 (DE) 10 2009 029 244.6

(51) Int. Cl. B01D 33/15

(52) U.S. Cl. 210/483

(57) ABSTRACT

The invention refers to a filter segment for use in a filtration device, especially a rotating filter for filtering liquids with a frame element (1) made at least partly of plastic and a filtration surface enclosing it, in which at least a flat filter material (2) spanning the filtration surface is embedded. According to the invention, it is suggested that within the frame element (1) at least one reinforcement (3) is arranged, for example, like a reinforcement frame and/or individual reinforcing elements traversing the entire frame element (1). Furthermore, the object of the invention is a circular segment for holding a minimum of one filter segment for use in a filtration device, especially a rotating filter for filtering liquids, whereby the circular segment has two opposing lateral sections, each one having one inner surface (11) for guiding the filter segment and a corresponding outer surface (9) executed as an adjacent surface for the corresponding outer surface (9) of another circular segment—and, in this case, the circular segment consists of detachable individual elements (6) linked to one another. The circular segment is finally characterized by the fact that at least two of the individual elements (6) have the same kind of structure.

This invention refers to a filter segment for use in a filtration device, especially in a rotating filter for filtering liquids with at least a partially plastic frame element that envelops a filtration surface and a flat filter material element spanning the filtration surface that is embedded in this frame element and a circular segment for holding at least one filter segment and for use in a filtration device, especially a rotating filter for filtering liquids, in which case the circular segment has two opposing lateral sections, each one with one inner surface for guiding the filter segment and a respective outer surface executed as an adjacent surface for the corresponding outer surface of a further circular segment—and in this case, the circular segment consists of detachable individual elements linked to each other.

These kinds of filter segments are used, for example, not only in the filtering of sewage but in other types of liquids as well that are polluted with undesired impurities. When used in rotating filters, they are mostly placed circularly or polygonally around a rotating hollow shaft, creating as a result of this the respective filtering disks and several of these filtering disks, in turn, can be arranged parallel to one another for increasing the effective filter surface. To ensure a sure guidance of the filter segments, they are mostly surrounded frame-like by the respective circular segments that can eventually be linked to one another for creating a stable framing for the filter segments. The basic objective in this is to simplify the structure of the respective filtering disks to facilitate above all a quick replacement of the filter segments during maintenance work, although adequate stability and guidance of the respective filter segments should nonetheless be ensured.

To satisfy these requirements, patent U.S. Pat. No. 6,231,761 B1 proposes a rotating filter whose filtering disks with numerous metal circular segments make contact with one another, in turn serving as guides for the corresponding filter segments. So they can be replaced, every circular segment has a cover element that can be detached from the remaining frame element.

Having as an objective to ensure the highest possible stability of the actual filter surfaces, in U.S. Pat. No. 2,444,147 A, the filtering disk has ribs running outwards in radial fashion and arranged between two adjacent filter membranes. This design prevents a deformation caused by the hydrostatic pressure acting on the filter surface, but the resulting filtering disk is also quite heavy owing to the additional cross-struts.

Consequently, although there are already the most varied filter element designs or circular segments serving as known frames, there is still improvement potential with regard to weight and manufacturing costs without sacrificing adequate stability.

The task of the invention is therefore to propose a filter segment and a corresponding circular segment for holding it that represent a further development of technical advances with regard to weight, cost, and form stability.

Concerning the filter segment, this task is solved by having a filter surface without intermediate cross-struts. On the one hand, this maximizes filter surface and on the other hand, this design also prevents dirt to accumulate on these cross-struts thus lowering filtration performance. Whereas conventional plastic frames always were or had to be stabilized with the intermediate cross-struts mentioned above, the frame element according to the invention has a self-supporting design, which therefore allows one to do away with such cross-struts. Apart from increasing filtration performance, the total weight is also reduced, so therefore a filter element that combines several advantages is proposed.

The big advantage here is that the frame element has a self-supporting design, especially owing to its geometrical shape and/or material composition.

Thus, the frame element can have, for example, cross-struts made of plastic or any other material. It is likewise also possible for it to be made of a material that already has adequate stability to ensure the self-supporting properties. Within this context, it is also possible to use high-strength plastic materials and/or plastics reinforced with special fibers such as fiberglass, for example. The frame element can also have several layers of various materials, in which case the respective composition of the material can also change in different places of the frame element. The result in these cases is that an internal metal frame, for example, is no longer necessary and the frame can also be more homogenous.

Alternatively or additionally, it can also be advantageous, however, for the frame element to have at least one reinforcement shaped like a reinforcement frame and/or individual reinforcement elements arranged inside that traverse the entire frame element. The advantages gained would not only have a positive impact on production costs but also on the reliability of such filter segments. Thus, in spite of a light-weight plastic sheathing, the resulting filter segments are very stiff due to the integrated reinforcement, and this stiffness is essential—particularly in view of the high filter performance and the fast current speeds taking place near the actual filter material—to ensure a long useful life, low follow-up costs and a reliable operation of the filtering installation. The reinforcement here can be shaped like a basic frame enveloped in plastic or a plastic frame shaped like individual reinforcing elements traversing it. In this case, it could for example be conceivable to reinforce only some sections like the corner areas or the longitudinal or transversal struts. The dimensions to be chosen here depend generally on the type of filtration device, the shape of the frame element or the load expected on the filter material. Likewise, the reinforcing frame or individual reinforcing elements can have any kind of profiles to achieve high stability in spite of low material utilization. Furthermore, it is also conceivable for the frame element itself to be made of individual parts having the same structure or a different one with a plastic envelope and reinforcements embedded in them.

It is also advantageous for the filter element to be thermally embedded. To achieve this, the plastic frame is slightly warmed up after the actual filter material is put on. To achieve good results, the temperature and/or duration should be chosen to soften up the plastic surface, When the plastic has finally reached the desired consistency, the melted plastic penetrates into some of the fibers of the filter material on the edges of the filter surface. Once the plastic has cooled down, one finally gets a form closure between frame element and filter material without needing additional materials such as adhesives or screwed connections.

It is also advantageous for the reinforcement to be made of metal, especially aluminum, iron and/or plastic such as glass fiber and/or plastic fiber, for example. Such materials are available in any consistency, and in this case the plastic envelope of the reinforcement has the advantage that pH- or temperature-sensitive materials such as conventional steel can be used because the reinforcement itself makes no contact with the liquids to be filtered.

An additional advantage is for the frame element to have at least one sealing lip that runs preferably perpendicular to the filtration surface and/or as extension of the filter material. Such a sealing lip, whose profile can naturally be adapted to the respective configurations of the filtration device, facilitates a reliable sealing with respect to the corresponding guides, for example in form of a circular segment that can in turn be assembled to create a filtering disk. Especially when rotating filters are used, two filter segments running parallel to one another are generally led through a circular segment, in which case a hollow space is created between the filter segments, into which eventually the liquid to be filtered penetrates and can flow out of the rotating filter after the filtration process. In this case, in particular, a reliable sealing of the filter segments with respect to the circular segment is necessary to prevent unfiltered liquid to flowing out of the hollow space mentioned above beside the actual filter surfaces.

The sealing lip should be preferably connected to the frame element, for example injected, or made as one part. Whereas the plastic selected for making the frame element in the latter case should preferably have a certain (surface) composition that facilitates the sealing of the filter segment from adjacent structural parts with a circular segment, for example, a separate sealing lip with especially hard or brittle types of plastic can be easily incorporated. Apart from injecting them, there are other attachment options in form of respective groove-spring connections or also various hot- or cold-bonding processes, for example.

Another further development of the invention consists of filter material made of metal gauze, preferably of stainless steel, a plastic and/or natural gauze, in which case the selection is guided by the type of filtration device, the liquid to be filtered (sewage, for example), the expected impurities and the desired filtration performance.

It is also advantageous for the frame element to be arranged between two filter material layers running parallel to one another that delimit a hollow space with it so that the resulting filter segment can also be used individually in rotating filters. Contrary to this, filter segments can also be arranged, of course, with only one layer of filter material with the help of the corresponding guide so that the hollow space mentioned above is created.

It is particularly advantageous for the frame element to be largely trapeze-shaped because filter segments with such a shape can be easily put together to create the corresponding filtering disks, in which case these resulting filtering disks have a centric opening through which most of the time a corresponding rotating axis generally developed as hollow shaft runs. Here, the frame elements can be in the form of a conventional trapeze with four lateral lines running linearly. However, it would also be advantageous for the base and the bottom side opposite it to be slightly arched so that the resulting filter disk would then have a circular circumferential line, whereby the line—in case linear frame elements are used—would have a polygonal shape.

Another special advantage would be for the filter material to be pre-stressed. This pre-stress is generally done while the filter material is being applied, either by stretching the filter material itself or compressing the frame element inwards. After the reinforcement process has ended, the filter material is finally tightened so that, on the one hand, the stability of the filter segment increases and, on the other hand, a continuously flat orientation of the filter surface is ensured. Optionally or alternatively, the use of filter materials that stretch a lot by adding heat is also possible. If such materials are applied to the frame element while still warm, then the desired pre-stress is also obtained after the filter segment has cooled off.

The circular segment for holding at least one filter segment is finally characterized by the fact that at least two of the individual elements have the same kind of structure. The decisive advantage of this is that only one single tool must be designed for these individual elements, so costs can be reduced a great deal. In this way, the circular segment can have a symmetrical structure consisting of only two individual elements, for example, and in this case the detachable connection of both individual elements nonetheless still allows the correspondingly included filter segment to be exchanged. In addition, the number of individual elements that need to be in stock decreases. Thus, a circular segment that is economical to manufacture, assemble and operate and nonetheless has the advantages of conventional circular segments is proposed. For purely precautionary reasons, it should be made clear in this context that the term “individual element” means exclusively circular segment elements that, when put together, form the basic body of the circular segment, so that no small parts such as screws or sealing elements, for example, are among them.

A further advantage is that the circular segment consists of no more than four, preferably no more than three, individual elements. Whereas a small number fits well with economic production of individual elements, more elaborately shaped circular elements can be made if their numbers increase. The numbers given above are ultimately a compromise of both aspects. In this respect, it has been proven useful to build a circular segment in such a way that it consists of two to three basic elements and a cover element pointing outwards if several circular segments are put together to create a filtering disk. As a result of this, an easy replacement of the guided filter segment is possible because only the cover element needs to be removed for doing this and the filter segment can be taken out in radial fashion. The remaining individual elements can remain connected to each other during the process so that the filtering disk does not need to be entirely taken apart.

It is also extremely advantageous if at least two of the individual elements are arranged mirror-symmetrically to ensure a uniform design and with it a uniform distribution of forces during the operation of the respective filtration device.

In this context. It can be particularly advantageous if at least two of the individual elements have a largely L-shaped structure. In this case, these elements—when assembled—create a U-shaped basic framing structure that is finally completed by one or several cover elements in such a way that a closed circular elements is the result of this. Several of these circular segments can, in turn, be assembled to create a filtering disk, in which case the cover element(s) is/are arranged along the resulting circumferential line of the filtering disk. After removing one or several cover elements, a simple assembly or disassembly of the corresponding filter segments is finally possible.

Last but not least, it is advantageous for the circular segment to have two guides spaced from one another that run largely parallel to each other for holding one filter segment each. Filter segments can finally be pushed into these guides, so that a hollow space is created between both filter surfaces into which the liquid to be filtered can be channeled. The guides can also have sealing elements for preventing the liquid to be filtered to penetrate beyond the actual filter surface. Likewise, the guides (which can have a U-shaped inner surface, for example) can run conically in one direction to allow a jamming of a filter segment, thus sealing it securely with respect to the circular segment.

Also advantageous is if at least two of the individual elements have a common connecting plane that runs perpendicularly to the outer surfaces. As a result of this, one gets circular segments that are at least symmetrical to a mirror surface, which in turn runs parallel to the filter surface of one or several built-in filter segments. When the filter segments are replaced, the respective individual elements can be finally separated from one another and once again put together after the new or serviced filter segment is inserted. In this case, the filter segment must not be pushed into the guides mentioned above but can easily be placed before putting together the individual elements as a kind of intermediate layer between the individual elements.

In an advantageous way, the individual elements are screwed, connected and/or bolted together to ensure a simple assembly, in which case the individual elements can be detached at any time to replace filter segments or service them out of the filtering device, for example.

Likewise, it can also be advantageous if a sealing elements is arranged between at least two individual elements. While it is naturally also possible to choose the surface composition of the individual elements that are preferably made of plastic so that sufficient sealing against the liquid to be filtered is ensured, the mounting of the corresponding sealing elements is a safe alternative to achieve the desired sealing.

It is furthermore advantageous if at least one individual element has a connecting element for linking it to an additional circular segment to eventually assemble several circular segments to create a resulting filtering disk, which in turn can have a perfectly circular or polygonal shape (with 8 or 10 corners, for example) depending on the form of the circular is segments.

Finally, the connecting element comprises advantageously a bore hole, a peg, a thread, a portion of a plug-in connector and/or a portion of a groove connection to have as a result of this a simple and nonetheless stable and easily detachable connection. In this case, the respective connecting elements can be separate structural components or also be shaped during the manufacturing of the individual elements.

Further advantages of the invention are described in connection with the exemplary embodiments described blow, which show:

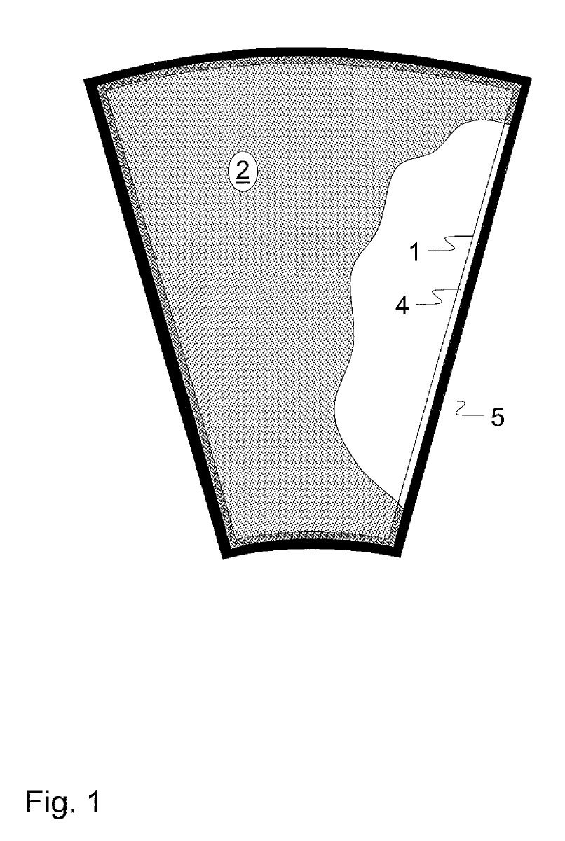

FIG. 1 a top view of a filter segment according to the invention,

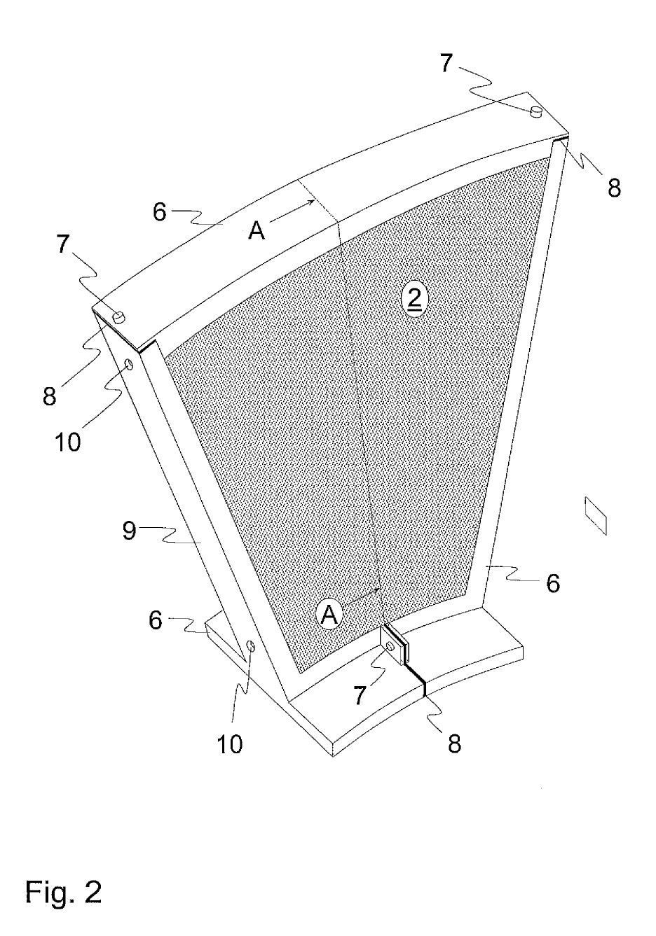

FIG. 2 a perspective view of a circular segment according to the invention with integrated filter segment,

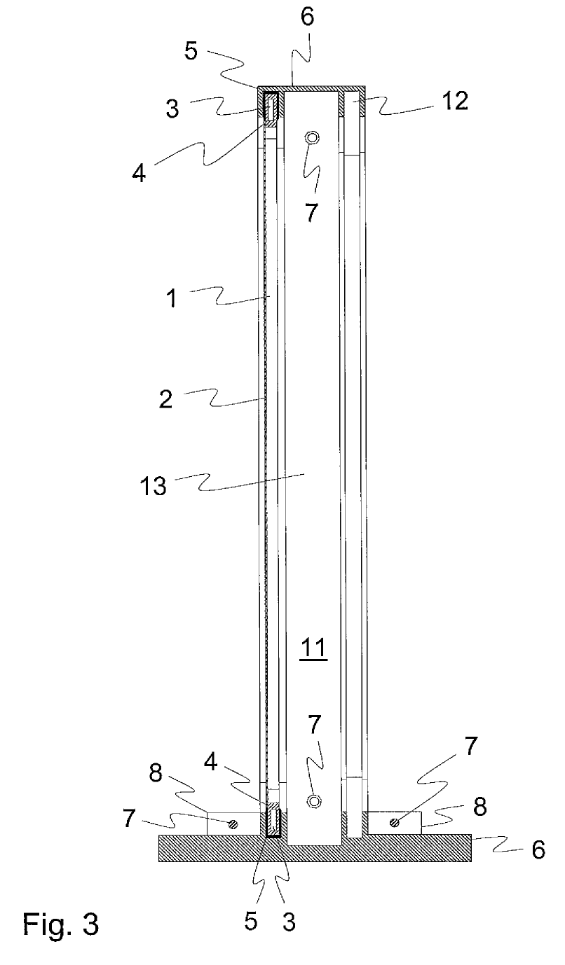

FIG. 3 a sectional view of the cutting line A in FIG. 2, and

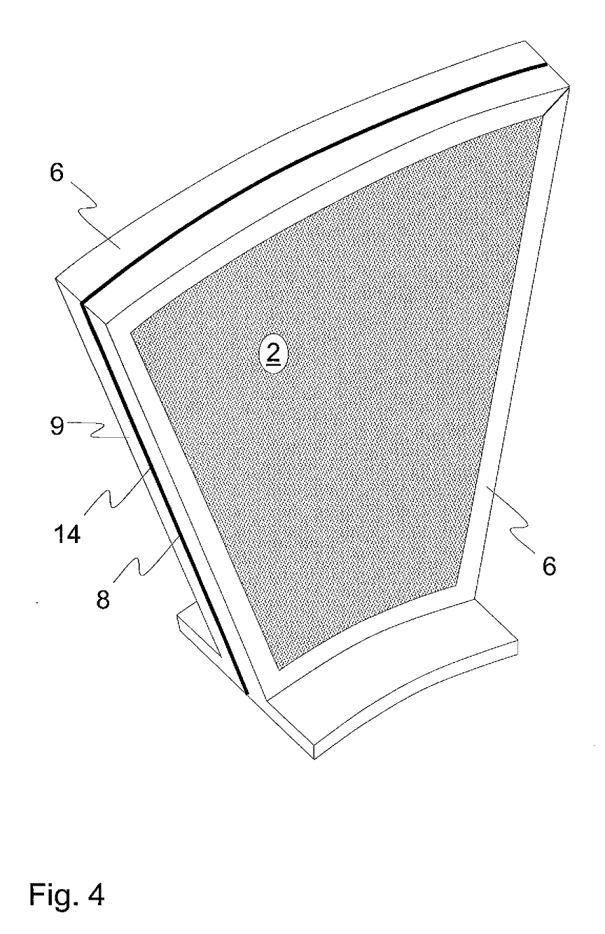

FIG. 4 another perspective view of the circular segment according to the invention with integrated filter segments.

FIG. 1 shows a top view of a filter segment according to the invention that consists of a frame element 1 that serves as supporting framing structure for the filter material 2 that creates the actual filtration surface. The frame element 1 has a plastic surface that can surround one or several reinforcements 3, for example in form of a reinforcement frame or individual reinforcing elements (see FIG. 3).

The filter material 2 made from gauze made of metal or plastic fibers, for example, is in turn embedded into the surface of the plastic frame, for example with the help of a melting process, at least partially along a connecting surface 4.

As can also be seen in FIG. 1, the filtration surface according to the invention has no cross-struts so that maximum filtration performance can be achieved in spite of the low weight of the filter segment. The frame element 1 has been designed to be self-supportive for this purpose, something made possible by selecting a dimensionally stable plastic or the corresponding construction of the frame element 1, for example, and in this case especially the basic shape or also the contour of the frame element 1 must be considered.

So the filter element can be sealed for a subsequent acceptance, preferably in the form of a circular segment according to the invention as shown in FIG. 2, the filter segment is surrounded by a sealing lip 5. Even if the latter runs circumferentially in the example shown, it is also possible to attach the respective sealing lips 5 only in some sections of the circumferential line and/or the respective sealings on the corresponding opposite surface of a circular segment.

FIG. 2 shows a perspective view of a circular segment according to the invention with two filter segments arranged parallel to each other with the resulting exact mutual arrangement seen in FIG. 3, later referred to in more detail.

In the embodiment of the invention, the circular segment consists of three individual elements 6, namely of three equal and L-shaped basic elements and a cover element lying above them that according to its distance allows the assembly or disassembly of the filter segments. All individual elements 6 are attached to one another in a detachable way with merely suggested screws 7 so that each individual element 6 or filter segment can be replaced at any time.

To secure a sealing between the respective individual elements 6 as well, sealing elements 8 have been arranged between them that, depending on the exact design of the individual elements 6, can have a flat or profiled design.

Both L-shaped individual elements 6 have, in turn, the respective outer surfaces 9 that represent the neighboring surfaces for the corresponding outer surfaces 9 of further neighboring circular segments. So several of the circular segments according to the invention can be linked together to create a filtering disk, connecting elements in the form of bore holes 10, for example, are arranged near the lateral sections. These serve finally for accepting the respective pegs or screws 7 (see FIG. 3) with which a reliable contact between two neighboring circular segments is ensured, in which case sealings (not shown) can also be naturally arranged between the respective outer surfaces 9. It is also optionally possible, however, for the outer surfaces 9 of the circular segment shown here in the assembled filtration device to be somewhat spaced apart from the corresponding outer surfaces 9 of additional circular segments so there is no direct contact.

Furthermore, FIG. 3 shows a sectional view along the suggested cutting line A of FIG. 2. As can be recognized, the individual elements 6 of the circular segment have two circumferential edges running parallel to their inner surface 11 that create the guides 12 for the filter segments, and in this case FIG. 3 merely shows one filter segment for a better understanding. In full assembled state, the filter segments finally delimit a hollow space 13 into which the liquid to be filtered is channeled to pass subsequently through the filter material 2.

The filter elements themselves have a reinforcement 3 in form of a reinforcement frame that runs through the entire frame element 1 and/or individual reinforcing elements. As a result of this, high stability of the filter segments is achieved in spite of the low weight, in which case the reinforcement 3 itself does not touch the liquid coming from the hollow space 13 that passes through the filter material 2. Thus, corrosion- or pH-sensitive materials such as conventional steel, can also be used as elements. Likewise, a reinforcement 3 may not be needed if the frame element 1 already has self-supportive properties owing to the corresponding choice of plastic and/or form. To achieve this, the frame element 1 can also have the most varied profiles that act, in turn, as frame-internal struts.

Finally, FIG. 4 shows another embodiment of the circular segment according to the invention and in this case, both of its individual elements 6 have a connecting plane 14 that runs parallel to the filter surfaces of the filter segments used, Even this embodiment eventually has the advantage that both individual elements 6 can have the same kind of structure to that only one single tool must be developed to manufacture them.

By the way, the invention is not restricted to the exemplary embodiments shown. Rather, all combinations of the individual characteristics as described in the claims, the description and the figures are technically feasible in combination or seem useful, are the object of the invention. Needless to say, the individual elements 6 of the circular segment according to the invention can naturally have reinforcements too, as described in connection with the filter segment.

### LIST OF REFERENCE SYMBOLS

1 Frame element
Filter material
3 Reinforcement
4 Connecting surface
5 Sealing lip
6 Individual element
7 Screw
8 Sealing element
9 Outer surface
10 Bore hole
11 Inner side
12 Guide
13 Hollow space
14 Connecting plane

1. Filter segment for use in a filtration device, especially a rotating filter for filtering liquids, with a frame element (1) made at least partly of plastic that envelops the filtration surface, in which at least one flat filter material (2) that spans the filtration surface is embedded, characterized in that, the filtration surface has no intermediate cross-struts.

2-21. (canceled)
